(19) United States
(12) Patent Application Publication
(10) Pub. No.: US 2012/0107679 A1
(43) Pub. Date: May 3, 2012

(54) NON-AQUEOUS ELECTROLYTE SECONDARY BATTERY

(75) Inventors: Kazuyuki TANIGUCHI, Annaka (JP); Satoru MIYAWAKI, Annaka (JP); Yoshiyasu YAMADA, Annaka (JP)

(73) Assignee: SHIN-ETSU CHEMICAL CO., LTD., Tokyo (JP)

(21) Appl. No.: 13/251,861

(22) Filed: Oct. 3, 2011

(30) Foreign Application Priority Data
Oct. 27, 2010 (JP) 2010-240383

(51) Int. Cl. H01M 10/056; H01M 4/48; H01M 4/134; B82Y 30/00

(52) U.S. Cl. 429/199; 429/188; 977/773

(57) ABSTRACT

The present invention is a non-aqueous electrolyte secondary battery including at least a positive electrode, a negative electrode and a non-aqueous electrolyte, the positive and negative electrodes being capable of occluding and emitting lithium ions, wherein the negative electrode is composed of particles each having a structure that silicon nanoparticles are dispersed to silicon oxide, each of the particles is coated with a carbon coating, and the non-aqueous electrolyte includes lithium oxalatoborate in the range of 5 to 10 mass %, as the electrolyte. As a result, there is provided a non-aqueous electrolyte secondary battery having high capacity, superior first charge and discharge efficiency, superior cycle performance, and high safety, while a manufacturing method and structure thereof are not complex.

### BACKGROUND OF THE INVENTION

1. Field of the Invention

The present invention relates to a non-aqueous electrolyte secondary battery having high capacity, high safety, and good cycle performance.

2. Description of the Related Art

As portable electronic equipment, communications instruments, and electrical cars are rapidly advanced in recent years, non-aqueous electrolyte secondary batteries having a high energy density and high capacity are strongly demanded from the aspects of cost, increase in lifetime, and size and weight reductions of the equipment.

As a method of using silicon oxide for a negative electrode material of the secondary battery, for example, there are known a method reported in Patent Literature 1, and a method of coating the surface of a silicon oxide particle with a carbon layer, reported in Patent Literatures 2 and 3. In the above-described conventional methods, however, cycle performance is insufficient, and it does not satisfy market demand characteristics yet, whereas charge and discharge capacity are improved and the energy density becomes high. Thus, they are not necessarily satisfied, and it is desired that the energy density is more improved.

In Patent Literature 1, a high capacity electrode can be obtained by using silicon oxide as the negative electrode material of the non-aqueous electrolyte secondary battery, such as a lithium secondary battery. As far as the inventors know, irreversible capacity at the first charge and discharge is still high, and the cycle performance has not reached a practical level. There is thus room for improvement particularly in Patent Literature 1.

Moreover, in the method of Patent Literature 2, the improvement of the cycle performance can be confirmed to a certain degree by the art of giving conductivity to the negative electrode. However, since the precipitation of a fine silicon crystal and the fusion between a carbon coating structure and a base material are insufficient, when the number of the cycle of charge and discharge is increased, a phenomenon is seen in which the capacity is gradually decreased and sharply decreased after a certain cycle number. There is thus a problem that the secondary battery is still inadequate.

Moreover, Patent Literature 3 has a problem that the carbon coating is not formed uniformly and the conductivity is insufficient, due to fusion between solids.

As a result of evaluation of the safety of the non-aqueous electrolyte secondary battery that was manufactured by the same design as a conventional battery having a graphite negative electrode and that had a silicon oxide negative electrode, a test result was obtained in which the battery having the silicon oxide negative electrode was inferior in safety, in a nail penetration test and a measurement test of a gas generation amount inside a cell.

These are items highly relevant to the safety and reliability of the battery, and measures are therefore required.

For the purpose of improving the battery safety, various methods have been devised and carried out up to the present.

As a method for preventing the battery from igniting at the nail penetration, there has been widely known measures by the improvement of battery components, such as use of a nonflammable electrolyte (Patent Literature 4), and use of an electrode and separator in which the surface thereof is coated with inorganic particles (Patent Literatures 5 and 6), and further, for a cylindrical and square battery, measures carried out at battery manufacture, for example, by arranging, in an outer circumferential portion of the electrode wound up, a current collector layer in which an active material is not applied, in addition to measures by incorporating a safety circuit into a module and a PTC device into a battery cell.

These measures are generally used in the battery having the graphite negative electrode, and highly contribute to the improvement of the safety. The measures do not much effect the improvement of the safety in the battery having the silicon oxide negative electrode, and therefore an additional safety measure is required.

The cause of the decrease in safety of the battery having the silicon oxide negative electrode can be considered as follows. First, the decrease in safety at the nail penetration is caused by generating a higher heat to ignite due to internal short circuit, because of a higher energy density in comparison with the battery having the graphite negative electrode.

Next, it is presumed that the cause of the increase in gas generation amount inside the battery is as follows.

It has been known that LiPF₆, which is used as the electrolyte of a common lithium ion secondary battery, causes the reaction represented by chemical formula (1), with water.

LiPF₆+H₂O→LiF+2HF+POF₃ (1)

It has been also known that SiO₂ causes the reaction represented by chemical formula (2), with HF.

SiO₂+4HF→SiF₄+2H₂O (2)

That is, it is considered that in the battery having the silicon oxide negative electrode, HF gas is generated by the reaction represented by chemical formula (1) between trace amounts of water present inside the battery and LiPF₆, which is the electrolyte, and the HF gas further causes the reaction represented by chemical formula (2), with SiO₂ contained in silicon oxide, so that a gas is generated. Moreover, it is presumed that since the reaction represented by chemical formula (2) causes the generation of water, the above-described two reactions are repeated inside the battery to generate a large amount of gas.

The battery in which lithium oxalatoborate is used as the non-aqueous electrolyte is reported in, for example, Patent Literatures 7 to 9. An example of the battery having a silicon or silicon oxide negative electrode is reported in Patent Literature 10.

The battery having the silicon oxide negative electrode, however, has low first charge and discharge efficiency, and the irreversible capacity is compensated by attaching a Li foil on a produced negative electrode sheet in Patent Literature 10. However, there are problems that a process for attaching the Li foil is needed and the electrode after the attachment has to be dealt with under a very dry atmosphere, and therefore further improvement is required.

### CITATION LIST

### Patent Literature

Patent Literature 1:Japanese Patent No. 2997741
Patent Literature 2:Japanese Unexamined Patent publication (Kokai) No. 2002-42806
Patent Literature 3:Japanese Unexamined Patent publication (Kokai) No. 2000-243396
Patent Literature 4:Japanese Unexamined Patent publication (Kokai) No. 2006-286571
Patent Literature 5:Japanese Unexamined Patent publication (Kokai) No. 2005-327680
Patent Literature 6:Japanese Unexamined Patent publication (Kokai) No. 2009-224341
Patent Literature 7:Japanese Unexamined Patent publication (Kokai) No. 2006-216378
Patent Literature 8:Japanese Unexamined Patent publication (Kokai) No. 2009-176534
Patent Literature 9:Japanese Unexamined Patent publication (Kokai) No. 2009-252489
Patent Literature 10:Japanese Unexamined Patent publication (Kokai) No. 2007-27084

### SUMMARY OF THE INVENTION

The present invention was accomplished in view of the aforementioned circumstances, and it is an object of the present invention to provide a non-aqueous electrolyte secondary battery having high capacity, superior first charge and discharge efficiency, superior cycle performance, and high safety, while a manufacturing method and structure thereof are not complex.

To solve the foregoing problems, the present invention provides a non-aqueous electrolyte secondary battery including at least a positive electrode, a negative electrode and a non-aqueous electrolyte, the positive and negative electrodes being capable of occluding and emitting lithium ions, wherein the negative electrode is composed of particles each having a structure that silicon nanoparticles are dispersed to silicon oxide, each of the particles is coated with a carbon coating, and the non-aqueous electrolyte includes lithium oxalatoborate in the range of 5 to 10 mass %, as the electrolyte.

In this manner, the particles each being coated with the carbon coating and each having the structure that silicon nanoparticles are dispersed to silicon oxide are used for the negative electrode, and the non-aqueous electrolyte including lithium oxalatoborate in the range of 5 to 10 mass % is used as the electrolyte. Thereby, in the non-aqueous electrolyte secondary battery, the capacity and the first charge and discharge efficiency are high, there is no problem in the nail penetration test, thus the safety is high, and the generation of gas inside the battery is more reduced than a conventional non-aqueous electrolyte secondary battery. Moreover, since the particles each being coated with the carbon coating and each having the structure that silicon nanoparticles are dispersed to silicon oxide are used for the negative electrode, and the non-aqueous electrolyte including lithium oxalatoborate in the range of 5 to 10 mass % is used as the electrolyte, the structure and the manufacturing method thereof are not complex in comparison with a conventional one, and thereby superior mass productivity is achieved.

Here, when the amount of the lithium oxalatoborate included in the non-aqueous electrolyte is less than 5 mass %, the suppression of the ignition from the battery at the nail penetration test and the suppression of the gas generation from the inside of the battery cannot be sufficiently achieved. When it is more than 10 mass %, salt is deposited in the non-aqueous electrolyte, this may cause the deterioration of the cycle performance, and thus a non-aqueous electrolyte secondary battery having a problem in cycle performance is obtained in this case. The content of the lithium oxalatoborate in the non-aqueous electrolyte is accordingly in the range of 5 to 10 mass %.

In this case, each of the particles having the structure that silicon nanoparticles are dispersed to silicon oxide is preferably composed of at least a silicon-silicon oxide composite having a structure that silicon particles having a size of 1 to 100 nm are dispersed to silicon oxide in an atomic order and/or a fine crystal state.

In this manner, when the silicon-silicon oxide composite having the structure that silicon particles having a size of 1 to 100 nm are dispersed to silicon oxide in an atomic order and/or a fine crystal state is used, the negative electrode having higher discharge capacity and better cycle durability can be obtained.

Moreover, the lithium oxalatoborate is preferably any one of lithium bis(oxalato)borate (LiBOB), lithium fluoro(oxalato)borate (LiFOB), and lithium difluoro(oxalato)borate (LiDFOB), or a mixture of two or more thereof.

In this manner, when the lithium oxalatoborate is any one of lithium bis(oxalato)borate (LiBOB), lithium fluoro(oxalato)borate (LiFOB), and lithium difluoro(oxalato)borate (LiDFOB), or a mixture of two or more thereof, the non-aqueous electrolyte secondary battery having good electrochemical stability and good hydrolysis resistance can be obtained.

As explained above, the present invention provides a non-aqueous electrolyte secondary battery in which the capacity and the first charge and discharge efficiency are high, the safety in the nail penetration test is superior, the generation of gas is reduced inside the battery, the manufacturing method is simple and convenient, and the manufacture can be achieved on an industrial scale.

### DETAILED DESCRIPTION OF THE PREFERRED EMBODIMENTS

Hereinafter, the present invention will be explained in detail, but the present invention is not restricted thereto.

The non-aqueous electrolyte secondary battery according to the present invention has at least the positive electrode and the negative electrode that are capable of occluding and emitting lithium ions, and the non-aqueous electrolyte. The negative electrode is composed of particles each being coated with a carbon coating and each having the structure that silicon nanoparticles are dispersed to silicon oxide. The non-aqueous electrolyte includes lithium oxalatoborate in the range of 5 to 10 mass %, as the electrolyte.

The non-aqueous electrolyte secondary battery having the above-described structure has higher capacity and higher first charge and discharge efficiency in comparison with a conventional one, since the particles each being coated with the carbon coating and each having the structure that silicon nanoparticles are dispersed to silicon oxide are used for the negative electrode. Moreover, when the non-aqueous electrolyte includes lithium oxalatoborate in the range of 5 to 10 mass %, as the electrolyte, the non-aqueous electrolyte secondary battery can be obtained in which the generation of ignition and smoking at the nail penetration test can be more suppressed, there is a fewer amount of the gas generation inside the battery, and the safety is higher in comparison with a conventional one.

Moreover, the battery structure itself is approximately the same as that of a common non-aqueous electrolyte secondary battery, and therefore it is readily manufactured. There is thus no problem with mass produce.

It is to be noted that when the amount of the lithium oxalatoborate included in the non-aqueous electrolyte is less than 5 mass %, the suppression of the ignition from the battery and the suppression of the gas generation from the inside of the battery at the nail penetration cannot be sufficiently achieved. When it is more than 10 mass %, salt is deposited in the non-aqueous electrolyte, and this may cause the deterioration of the cycle performance unappropriately.

Hereinafter, the positive electrode, the negative electrode, and the non-aqueous electrolyte constituting the non-aqueous electrolyte secondary battery according to the present invention will be explained in more detail.

First, the negative electrode will be explained.

As described above, the negative electrode is composed of the particles each being coated with the carbon coating and each having the structure that silicon nanoparticles are dispersed to silicon oxide.

It is to be noted that silicon oxide described in the present invention means a generic name of amorphous silicon oxide represented by a general formula of SiOₓ (0.5×1.5), unless otherwise noted.

The silicon oxide can be obtained by cooling a silicon oxide gas produced by heating a mixture of carbon dioxide and metallic silicon, and precipitating the silicon oxide.

For example, the particle having the structure that silicon nanoparticles are dispersed to silicon oxide, which is to be a raw material of the negative electrode, can be obtained by performing, on a silicon oxide particle represented by the general formula of SiOₓ (0.5×1.5), a heat treatment at a temperature of 400° C. or more, and preferably temperatures ranging 800 to 1100° C. under an inert and non-oxidizing atmosphere, such as an argon, to cause disproportionation reaction.

This is composed of the silicon-silicon oxide composite having the structure that silicon particles having a size of 1 to 100 nm are dispersed to silicon oxide in an atomic order and/or a fine crystal state. The negative electrode can thereby have higher discharge capacity and better cycle durability in comparison with a conventional one. It is to be noted that it can be confirmed by a transmission electron microscope that the silicon nanoparticles are dispersed to silicon oxide having non-fixed form.

The physical properties of the particle having the structure that silicon nanoparticles are dispersed to silicon oxide is appropriately selected according to a target composite particle. An average particle size thereof is desirably 0.1 to 50 μm. A lower limit of the size is desirably 0.2 μm or more, and more desirably 0.5 μm or more. An upper limit thereof is desirably 30 μm or less, and more desirably 20 μm or less. It is to be noted that the average particle size described in the present invention means a volume average particle size in particle size distribution measurement by the laser diffractometry.

Moreover, the BET specific surface area of the particle having the structure that silicon nanoparticles are dispersed to silicon oxide is desirably 0.5 to 100 m²/g, and more desirably 1 to 20 m²/g.

In the present invention, the particle having the structure that silicon nanoparticles are dispersed to silicon oxide is coated with the carbon coating.

A preferred method for forming the carbon coating is a method in which the composite particles are subjected to chemical vapor deposition (CVD) in an organic gas. This method can be efficiently performed by introducing the organic gas into a reactor during a heat treatment.

Specifically, the carbon coating can be obtained by performing the chemical vapor deposition on the particle having the structure that silicon nanoparticles are dispersed to silicon oxide in an organic gas at a temperature of 700 to 1,200° C. under a reduced pressure of 50 to 30,000 Pa. The pressure is desirably 50 to 10,000 Pa, and more desirably 50 to 2,000 Pa. When the reduced pressure is 30,000 Pa or less, it can be avoided that the proportion of graphite material having a graphite structure becomes too large, and thereby the battery capacity and cycle performance are decreased in the case of using it for the negative electrode of the non-aqueous electrolyte secondary battery.

Moreover, the temperature of the chemical vapor deposition is desirably 800 to 1,200° C., and more desirably 900 to 1,100° C. When the treatment temperature is 700° C. or more, the treatment is not needed to be performed for a long time. When it is 1,200° C. or less, there is no possibility of fusion and aggregation of particles during the chemical vapor deposition treatment, and a conductive coating is not formed on an aggregated surface. Therefore, the cycle performance is not decreased in the case of using it for the negative electrode of the non-aqueous electrolyte secondary battery.

It is to be noted that the treatment time is appropriately selected according to a target carbon coating amount, treatment temperature, concentration (flow rate) and introducing amount of the organic gas, and the like. Typically, a treatment time of 1 to 10 hours, and particularly approximately 2 to about 7 hours, is economically efficient.

As the organic material used as a raw material that generates an organic gas in the present invention, an organic material capable of pyrolysis at the above-mentioned heat-treatment temperature to produce carbon (graphite), particularly in a non-oxidizing atmosphere, is selected.

Examples of such organic materials include chained hydrocarbons such as methane, ethane, ethylene, acetylene, propane, butane, butene, pentane, isobutane, and hexane; cyclic hydrocarbons such as cyclohexane; a mixture thereof; monocyclic to tricyclic aromatic hydrocarbons such as benzene, toluene, xylene, styrene, ethylbenzene, diphenylmethane, naphthalene, phenol, cresol, nitrobenzene, chlorobenzene, indene, cumarone, pyridine, anthracene, and phenanthrene; and a mixture thereof. Additionally, gas light oils, creosote oils, anthracene oils, naphtha-cracked tar oils, and the like that are produced in the tar distillation process can be used alone or as a mixture.

The amount of the carbon coating is not restricted in particular. It is desirably 0.3 to 40 mass %, and more desirably 0.5 to 20 mass %, with respect to all particles coated with the carbon coating.

When the amount of the carbon coating is 0.3 mass % or more, sufficient conductivity can be maintained. As a result, the cycle performance when it is used for the negative electrode of the non-aqueous electrolyte secondary battery can be surely improved. When it is 40 mass % or less, the effect of the coating can be improved, and the decrease in charge and discharge capacity due to the increase in proportion of graphite contained in the negative electrode material can be surely avoided.

The physical properties of the composite particle after coating with the carbon coating is not restricted in particular. An average particle size thereof is desirably 0.1 to 50 μm. A lower limit of the size is desirably 0.2 μm or more, and more desirably 0.5 μm or more. An upper limit thereof is desirably 30 μm or less, and more desirably 20 μm or less. It is to be noted that the average particle size means a volume average particle size in particle size distribution measurement by the laser diffractometry.

When the average particle size is 0.1 μm or more, the proportion of silicon oxide on the particle surface becomes large due to the increase in specific surface area, and the battery capacity when it is used for the negative electrode of the non-aqueous electrolyte secondary battery can be thereby prevented from decreasing. When it is 50 μm or less, the decrease in battery characteristics, caused by changing it to an extraneous substance when applying it to the electrode, can be prevented.

The BET specific surface area of the particle after coating with the carbon coating is desirably 0.5 to 100 m²/g, and more desirably 1 to 20 m²/g.

When the BET specific surface area is 0.5 m²/g or more, the decrease in battery characteristics due to the decrease in adhesiveness when applying it to the electrode can be prevented. When it is 100 m²/g or less, the proportion of silicon oxide on the particle surface becomes large and the battery capacity when it is used for the negative electrode of a lithium ion secondary battery can be thereby prevented from decreasing.

It is to be noted that a conductive agent such as carbon and graphite can be added to the negative electrode in the above-described non-aqueous electrolyte secondary battery. In this case, the type of the conductive agent is not restricted in particular. The conductive agent may be any electrically conductive material that does not cause decomposition and deterioration in the constituted battery.

Specific examples of usable conductive agents include metal particles or metal fibers of Al, Ti, Fe, Ni, Cu, Zn, Ag, Sn, Si, and the like, natural graphite, synthetic graphite, various types of coke powders, meso-phase carbon, vapor phase grown carbon fibers, pitch base carbon fibers, PAN base carbon fibers, and graphite obtained by firing various resins.

Moreover, the non-aqueous electrolyte includes a non-aqueous organic solvent and the lithium oxalatoborate dissolved therein as the electrolyte.

The amount of the lithium oxalatoborate included in the non-aqueous electrolyte is in the range of 5 to 10 mass %. The type thereof is not restricted in particular as long as it is known as lithium oxalatoborate used as the electrolyte of the non-aqueous electrolyte secondary battery, and can be appropriately selected.

Examples of the lithium oxalatoborate include a compound such as lithium bis(oxalato)borate (LiBOB), lithium fluoro(oxalato)borate (LiFOB), and lithium difluoro(oxalato)borate (LiDFOB), and a mixture of these. In particular, any one of these or a mixture of two or more of these enables the non-aqueous electrolyte secondary battery having good electrochemical stability and good hydrolysis resistance.

Moreover, as long as the lithium oxalatoborate is included in the range of 5 to 10 mass %, an electrolyte other than the lithium oxalatoborate can be also used, and a generally known electrolyte of the non-aqueous electrolyte secondary battery can be selected without particular restriction.

Examples of this include LiPF₆, L±N(CF₃SO₂)₂, LiN(C₂F₅SO₂)₂, LiClO₄, LiBF₄, LiSO₃CF₃ and a mixture of these.

The non-aqueous organic solvent is not restricted in particular as long as it is known as a solvent used for the electrolyte of the non-aqueous electrolyte secondary battery, and can be appropriately selected and used.

Examples of the solvents include cyclic carbonate such as ethylene carbonate, propylene carbonate, fluoroethylene carbonate, and difluoroethylene carbonate; chain carbonate such as dimethyl carbonate, diethyl carbonate, and ethyl methyl carbonate; a organic solvent such as γ-butyrolactone, dimethoxyethane, tetrahydropyran, N,N-dimethylformamide, and fluorine-containing ether (See Japanese Unexamined Patent publication (Kokai) No. 2010-146740); and a mixture of these.

Moreover, an optional additive can be used with an appropriate amount in these non-aqueous organic solvent. Examples of the additives include cyclohexylbenzene, biphenyl, vinylene carbonate, succinic anhydrite, ethylene sulfite, propylene sulfite, dimethyl sulfite, propane sultone, butane sultone, methyl methanesulfonate, methyl toluenesulfonate, dimethyl sulfate, ethylene sulfate, sulfolane, dimethyl sulfone, diethyl sulfone, dimethyl sulfoxide, diethyl sulfoxide, tetramethylene sulfoxide, diphenyl sulfide, thioanisole, diphenyl disulfide, dipyridinium disulfide.

Examples of usable positive electrode capable of occluding and emitting lithium ions include an oxide of transition metal such as LiCoO₂, LiNiO₂, LiMn₂O₄, LiNiMnCoO₂, LiFePO₄, LiVOPO₄, V₂O₅, MnO₂, TIS₂, and MoS₂, and lithium, and chalcogen compounds.

The non-aqueous electrolyte secondary battery according to the present invention is characterized by including the positive electrode, negative electrode, and electrolyte having the above-described features. Other constitution such as a material of a separator and the like, and a battery shape, can be the same as a heretofore known battery, without restriction.

For example, the shape of the non-aqueous electrolyte secondary battery is optional, and is not restricted in particular.

In general, the battery is of the coin type in which electrodes and a separator, all punched into coin shape, are stacked, or of the rectangular or cylinder type in which electrode sheets and a separator are spirally wound.

The separator disposed between the positive and negative electrodes is not restricted in particular as long as it is stable to the electrolytic solution and holds the solution effectively.

General separators include a porous sheet or non-woven fabric of polyolefins, such as polyethylene and polypropylene, of copolymers thereof and of aramide resins. These sheets may be used as a single layer or a laminate of multiple layers. Ceramics such as metal oxides may be deposited on the surface of sheets. Porous glass and ceramics are used as well.

### EXAMPLES

Hereinafter, the present invention will be more specifically explained by showing Examples and Comparative Examples. However, the present invention is not restricted thereto, and can be appropriately change within a scope of technical features described in claims.

### Example 1

### Electrode Fabrication

A powder in which silicon nanoparticles are dispersed to silicon oxide, the powder having an average particle size of 5 μm and being coated by carbon with 15 mass % was prepared. The powder of 90 mass % was mixed with polyimide of 10 mass %, and N-methylpyrrolidone was further added thereto to form a slurry.

The slurry was applied to both surfaces of a copper foil having a thickness of 11 μm, and dried for 30 minutes at 100° C. An electrode was thereafter formed by pressing with a roller press. This electrode was vacuum-dried for 2 hours at 400° C., and subsequently cut into a dimension of 5.8 cm in length and 75 cm in width to obtain the negative electrode. In this case, the cutting was performed so as to form a portion having a width of 2 cm and a portion having a width of 6 cm, where the slurry was not applied, at both ends of the electrode respectively.

Moreover, lithium cobaltate of 94 mass %, acetylene black of 3 mass %, and polyvinylidene fluoride of 3 mass % were mixed, and N-methylpyrrolidone was further added thereto to form a slurry. The slurry was applied to an aluminum foil having a thickness of 16 μm.

It was dried for 1 hour at 100° C., and an electrode was thereafter formed by pressing with a roller press. This electrode was vacuum-dried for 5 hours at 120° C., and subsequently cut into a dimension of 5.7 cm in length and 69 cm in width to obtain the positive electrode. In this case, the cutting was performed so as to form, at both ends of the electrode, portions having a width of 2 cm and 6 cm respectively, where the slurry was not applied.

### <Electrolyte Preparation>

To prepare the non-aqueous electrolyte, a solution was obtained by dissolving LiPF₆ into a mixed solution of ethylene carbonate:diethyl carbonate=1:1 (volume ratio) so as to have a concentration of 1 mol/L, and LiBOB was dissolved into the solution so as to have 5 mass % with respect to the electrolyte. It is to be noted that the preparation of the electrolyte was carried out in a glove box filled with an argon gas to prevent moisture in the air from diffusing in the electrolyte.

### <Cylindrical Battery Manufacture>

A cylindrical lithium ion secondary battery for evaluation was manufactured by using the fabricated negative electrode and positive electrode, the prepared non-aqueous electrolyte, and a separator of a polypropylene microporous film having a thickness of 20 μm.

### <Battery Evaluation>

The manufactured cylindrical lithium ion secondary battery was allowed to stand overnight at room temperature, and thereafter charged and discharged with a secondary battery charge/discharge test apparatus (made by ASKA Electronic Co., Ltd.). First, it was charged at a constant current of 300 mA/cm² until a test cell voltage reached 4.2 V. After the voltage reached 4.2 V, the battery was charged at a reduced current so that the cell voltage was maintained at 4.2 V. When the current value had decreased below 50 mA/cm², the charging was terminated. The battery was discharged at a constant current of 300 mA/cm², and the discharging was terminated when the cell voltage reached 2.5 V. The charge and discharge capacity, and the first efficiency were obtained by the above-described operation.

The above-described charge and discharge tests were repeated, and the charge and discharge test of the lithium ion secondary battery for evaluation was carried out after 50 cycles. The result is shown in Table 1.

### <Nail Penetration Test>

The manufactured cylindrical battery was charged and discharged in 50 cycles by the above-described method for evaluating the battery and thereafter taken out in a full charged status, and the nail penetration test was carried out. The result is shown in Table 1.

### <Gas Generation Test>

The powder of 0.5 g used for the negative electrode of the cylindrical lithium ion secondary battery for evaluation was put into an aluminum laminated bag. The laminate was sealed after adding the electrolyte of 0.5 g used for the lithium ion secondary battery for evaluation, and allowed to stand at 120° C. for two weeks. The amount of internal generation gas was calculated on the basis of the change in volume of the laminated bag between before and after heating. The result is shown in Table 1.

### Example 2

A battery was manufactured and evaluated in the following manner.

The non-aqueous electrolyte was prepared by dissolving LiBOB of 10 mass % into a mixed solution of ethylene carbonate:diethyl carbonate=1:1 (volume ratio). It is to be noted that the preparation of the electrolyte was carried out in a glove box filled with an argon gas to prevent moisture in the air from diffusing in the electrolyte.

A cylindrical lithium ion secondary battery for evaluation was manufactured by the same method as Example 1 by using positive and negative electrodes manufactured by the same method as Example 1 and the prepared non-aqueous electrolyte.

The same battery evaluation, nail penetration test, and gas generation test as Example 1 were carried out on the manufactured lithium ion secondary battery. The result is shown in Table 1.

### Example 3

A battery was manufactured and evaluated in the following manner.

To prepare the non-aqueous electrolyte, a solution was obtained by dissolving LiPF₆ into a mixed solution of ethylene carbonate:diethyl carbonate=1:1 (volume ratio) so as to have a concentration of 1 mol/L, and LiFOB was dissolved into the solution so as to have 5 mass % with respect to the electrolyte. It is to be noted that the preparation of the electrolyte was carried out in a glove box filled with an argon gas to prevent moisture in the air from diffusing in the electrolyte.

A cylindrical lithium ion secondary battery for evaluation was manufactured by the same method as Example 1 by using positive and negative electrodes manufactured by the same method as Example 1 and the prepared non-aqueous electrolyte.

The same battery evaluation, nail penetration test, and gas generation test as Example 1 were carried out on the manufactured lithium ion secondary battery. The result is shown in Table 1.

### Comparative Example 1

A battery was manufactured and evaluated in the following manner.

A cylindrical lithium ion secondary battery for evaluation was manufactured by the same method as Example 1 by using positive and negative electrodes manufactured by the same method as Example 1 and a solution obtained by dissolving LiPF₆ into a mixed solution of ethylene carbonate:diethyl carbonate=1:1 (volume ratio) so as to have a concentration of 1 mol/L, as the electrolyte.

The same battery evaluation, nail penetration test, and gas generation test as Example 1 were carried out on the manufactured lithium ion secondary battery. The result is shown in Table 1.

### Comparative Example 2

A battery was manufactured and evaluated in the following manner.

Synthetic graphite (an average particle size of 10 μm) of 45 mass % was mixed with polyimide of 10 mass % and powder of 45 mass % in which the silicon nanoparticles having an average particle size of 5 μm and having a BET specific surface area of 3.5 m²/g are dispersed to silicon oxide, and N-methylpyrrolidone was further added thereto to form a slurry. The slurry was applied to a copper foil having a thickness of 11 μm, and dried for 30 minutes at 100° C. An electrode was thereafter formed by pressing with a roller press. This electrode was vacuum-dried for 2 hours at 400° C., and subsequently cut into a dimension of 5.8 cm in length and 75 cm in width to obtain the negative electrode.

A cylindrical lithium ion secondary battery for evaluation was manufactured by using the manufactured negative electrode, and a positive electrode and an electrolyte prepared by the same method as Example 1.

The same battery evaluation, nail penetration test, and gas generation test as Example 1 were carried out on the manufactured lithium ion secondary battery. The result is shown in Table 1.

### Comparative Example 3

A battery was manufactured and evaluated in the following manner.

A cylindrical lithium ion secondary battery for evaluation was manufactured by the same method as Example 1 by using positive and negative electrodes manufactured by the same method as Example 1 and a solution obtained by dissolving LiN(C₂F₅SO₂)₂ into a mixed solution of ethylene carbonate:diethyl carbonate=1:1 (volume ratio) so as to have a concentration of 1 mol/L, as the electrolyte.

The same battery evaluation, nail penetration test, and gas generation test as Example 1 were carried out on the manufactured lithium ion secondary battery. The result is shown in Table 1.

### Comparative Example 4

A battery was manufactured and evaluated in the following manner.

To prepare the non-aqueous electrolyte, a solution was obtained by dissolving LiPF₆ into a mixed solution of ethylene carbonate:diethyl carbonate=1:1 (volume ratio) so as to have a concentration of 1 mol/L, and LiBOB was dissolved into the solution so as to have 3 mass % with respect to the electrolyte. It is to be noted that the preparation of the electrolyte was carried out in a glove box filled with an argon gas to prevent moisture in the air from diffusing in the electrolyte.

A cylindrical lithium ion secondary battery for evaluation was manufactured by the same method as Example 1 by using positive and negative electrodes manufactured by the same method as Example 1 and the prepared non-aqueous electrolyte.

The same battery evaluation, nail penetration test, and gas generation test as Example 1 were carried out on the manufactured lithium ion secondary battery. The result is shown in Table 1.

### Comparative Example 5

A battery was manufactured and evaluated in the following manner.

To prepare the non-aqueous electrolyte, a solution was obtained by dissolving LiPF₆ into a mixed solution of ethylene carbonate:diethyl carbonate=1:1 (volume ratio) so as to have a concentration of 1 mol/L, and it was attempted to dissolve LiBOB into the solution so as to have 12 mass % with respect to the electrolyte. However, the LiBOB was not able to be dissolved completely, and the electrolyte became clouded. It is to be noted that the preparation of the electrolyte was carried out in a glove box filled with an argon gas to prevent moisture in the air from diffusing in the electrolyte.

It was attempted that a cylindrical lithium ion secondary battery for evaluation was manufactured by the same method as Example 1 by using positive and negative electrodes manufactured by the same method as Example 1 and the prepared non-aqueous electrolyte. However, the non-aqueous electrolyte was not impregnated into the electrode and separator sufficiently, and the battery evaluation, nail penetration test, and gas generation test were not therefore carried out.

TABLE 1

| | | | FIRST | CAPACITY | | |
|---|---|---|---|---|---|---|
| | | | CHARGE AND | RETENTION | | GAS |
| | NEGATIVE | | DISCHARGE | RATIO | NAIL | GENERATION |
| | ELECTRODE | | EFFICIENCY | AFTER 50 | PENETRATION | AMOUNT |
| | MATERIAL | ELECTROLYTE | (%) | CYCLES (%) | TEST | (mL) |
| EXAMPLE 1 | CARBON | LiPF₆ (1M) + | 70 | 90 | NO IGNITION/ | 3.0 |
| | COATING + | LiBOB (5 wt %) | | | SMOKING | |
| | SILICON | | | | | |
| | OXIDE | | | | | |
| EXAMPLE 2 | CARBON | LiBOB (10 wt %) | 71 | 91 | NO IGNITION/ | 0.0 |
| | COATING + | | | | SMOKING | |
| | SILICON | | | | | |
| | OXIDE | | | | | |
| EXAMPLE 3 | CARBON | LiPF₆ (1M) + | 70 | 91 | NO IGNITION/ | 2.7 |
| | COATING + | LiFOB (5 wt %) | | | SMOKING | |
| | SILICON | | | | | |
| | OXIDE | | | | | |
| COMPARATIVE | CARBON | LiPF₆ (1M) | 69 | 90 | IGNITION | 25.0 |
| EXAMPLE 1 | COATING + | | | | | |
| | SILICON | | | | | |
| | OXIDE | | | | | |
| COMPARATIVE | SILICON | LiPF₆ (1M) + | 64 | 88 | NO IGNITION/ | 0.5 |
| EXAMPLE 2 | OXIDE | LiBOB (5 wt %) | | | SMOKING | |
| | ONLY | | | | | |
| COMPARATIVE | CARBON | LiN(C₂F₅SO₂)₂ | 70 | 85 | IGNITION | 0.0 |
| EXAMPLE 3 | COATING + | (1M) | | | | |
| | SILXCON | | | | | |
| | OXIDE | | | | | |
| COMPARATIVE | CARBON | LiPF₆ (1M) + | 70 | 90 | IGNITION | 5.0 |
| EXAMPLE 4 | COATING + | LiBOB (3 wt %) | | | | |
| | SILICON | | | | | |
| | OXIDE | | | | | |
| COMPARATIVE | CARBON | LiBOB (12 wt %) | — | — | — | — |
| EXAMPLE 5 | COATING + | | | | | |
| | SILICON | | | | | |
| | OXIDE | | | | | |

According to the charge and discharge tests, as shown in Table 1, the first charge capacity was 3050 mAh/g, the first discharge capacity was 2150 mAh/g, the first charge and discharge efficiency was 70%, and a capacity retention ratio after 50 cycles was 90%, in Example 1. It was thus confirmed that the lithium ion secondary battery in Example 1 had high capacity, superior first charge and discharge efficiency, and superior cycle performance. In Example 2, the first charge capacity was 2950 mAh/g, the first discharge capacity was 2100 mAh/g, the first charge and discharge efficiency was 71%, a capacity retention ratio after 50 cycles was 91%, and it was thus confirmed that the lithium ion secondary battery in Example 2 also had high capacity, and superior cycle performance. In Example 3, the first charge capacity was 2860 mAh/g, the first discharge capacity was 2000 mAh/g, the first charge and discharge efficiency was 70%, a capacity retention ratio after 50 cycles was 91%, and it was thus confirmed that the lithium ion secondary battery in Example 3 also had high capacity and superior cycle performance.

In Comparative Example 1, the first charge capacity was 3030 mAh/g, the first discharge capacity was 2090 mAh/g, the first charge and discharge efficiency was 69%, and a capacity retention ratio after 50 cycles was 90%. In Comparative Example 4, the first charge capacity was 2900 mAh/g, the first discharge capacity was 2030 mAh/g, the first charge and discharge efficiency was 70%, and a capacity retention ratio after 50 cycles was 90%. It was confirmed that the lithium ion secondary battery in Comparative Examples 1 and 4 had high capacity and superior cycle performance.

In Comparative Example 2, however, the first charge capacity was 2750 mAh/g, the first discharge capacity was 1760 mAh/g, the first charge and discharge efficiency was 64%, a capacity retention ratio after 50 cycles was 88%. It was thus confirmed that the lithium ion secondary battery in Comparative Example 2 had high capacity and superior cycle performance, but the first charge and discharge efficiency was considerably decreased in comparison with Example 1. In Comparative Example 3, the first charge capacity was 2970 mAh/g, the first discharge capacity was 2080 mAh/g, the first charge and discharge efficiency was 70%, a capacity retention ratio after 50 cycles was 85%. The deterioration in cycle performance was also confirmed, although it had high capacity.

In Examples 1 to 3 and Comparative Examples 2 and 5, both of the ignition and smoking were not generated during the nail penetration test.

On the other hand, in Comparative Examples 1, 3, and 4, the ignition and smoking from the battery were confirmed, and it was thus revealed that the safety was not sufficiently high.

The amount of internal gas generation was evaluated on the basis of the change in volume of the laminated bag between before and after heating. In Example 1, the gas generation amount was 3 mL. In Example 2, the gas was not generated. In Example 3, the gas generation amount was 2.7 mL. In Comparative Example 2, the gas generation amount was 0.5 mL. In Comparative Examples 3 and 5, the gas was not generated.

On the other hand, in Comparative Example 1, the gas generation amount was 25 mL, and a large amount of gas generation was thus confirmed. In Comparative Example 4, the gas generation amount was 5 mL.

Here, the reason that the gas generation was not confirmed in Comparative Example 3 can be considered as follows. Since the electrolyte did not include LiPF₆, the reactions represented by the above-described chemical formulas (1) and (2) were not caused, and therefore the gas was not generated.

As described above, in the batteries of Examples 1 to 3, which included the negative electrode composed of the particles each having the structure that silicon nanoparticles are dispersed to silicon oxide and each being coated with the carbon coating, and the non-aqueous electrolyte including lithium oxalatoborate in the range of 5 to 10 mass %, as the electrolyte, there was no problem in battery characteristics and safety. On the other hand, Comparative Examples 1 and 3 in which the lithium oxalatoborate was not included had problems in safety and battery characteristics. Comparative Example 2 in which the carbon coating was not formed had a problem in battery characteristics. Comparative Example 4 in which the content of the lithium oxalatoborate was smaller than 5 mass % had a problem in safety. Comparative Example 5 in which the content of the lithium oxalatoborate was larger than 10 mass % had a problem that LiBOB was not dissolved into the electrolyte completely.

It is to be noted that the present invention is not restricted to the foregoing embodiment. The embodiment is just an exemplification, and any examples that have substantially the same feature and demonstrate the same functions and effects as those in the technical concept described in claims of the present invention are included in the technical scope of the present invention.

What is claimed is:

1. A non-aqueous electrolyte secondary battery comprising at least a positive electrode, a negative electrode and a non-aqueous electrolyte, the positive and negative electrodes being capable of occluding and emitting lithium ions, wherein
the negative electrode is composed of particles each having a structure that silicon nanoparticles are dispersed to silicon oxide,
each of the particles is coated with a carbon coating, and
the non-aqueous electrolyte includes lithium oxalatoborate in the range of 5 to 10 mass %, as the electrolyte.

2. The non-aqueous electrolyte secondary battery according to claim 1, wherein each of the particles having the structure that silicon nanoparticles are dispersed to silicon oxide is composed of at least a silicon-silicon oxide composite having a structure that silicon particles having a size of 1 to 100 nm are dispersed to silicon oxide in an atomic order and/or a fine crystal state.

3. The non-aqueous electrolyte secondary battery according to claim 1, wherein the lithium oxalatoborate is any one of lithium bis(oxalato)borate (LiBOB), lithium fluoro(oxalato)borate (LiFOB), and lithium difluoro(oxalato)borate (LiDFOB), or a mixture of two or more thereof.

4. The non-aqueous electrolyte secondary battery according to claim 2, wherein the lithium oxalatoborate is any one of lithium bis(oxalato)borate (LiBOB), lithium fluoro(oxalato)borate (LiFOB), and lithium difluoro(oxalato)borate (LiDFOB), or a mixture of two or more thereof.
